(19) United States
(12) Patent Application Publication
(10) Pub. No.: US 2007/0127354 A1
(43) Pub. Date: Jun. 7, 2007

(54) OPTICAL DISC AND METHOD FOR FABRICATING THE SAME

(75) Inventor: Chih-feng Lin, Hsinchu (TW)

Correspondence Address: PAI PATENT & TRADEMARK LAW FIRM, 1001 FOURTH AVENUE, SUITE 3200, SEATTLE, WA, 98154, US

(73) Assignees: PRINCO CORP., Hsinchu (TW); PRINCO AMERICA CORP., Fremont, CA (US)

(21) Appl. No.: 11/561,390

(22) Filed: Nov. 18, 2006

(30) Foreign Application Priority Data
Dec. 2, 2005 (TW) 94142438

(51) Int. Cl. G11B 7/24

(52) U.S. Cl. 369/275.4

(57) ABSTRACT

An optical disc includes an annular substrate, a coating layer, and a compensation sheet. The annular substrate has a supporting portion, a recording portion surrounding the supporting portion, and a recording surface corresponding to the recording portion. The coating layer is formed on the recording surface for recording data. The compensation sheet is attached to the annular substrate so that the coating layer is sandwiched between the annular substrate and the compensation sheet, and that the thickness of the optical disc at the recording portion is the same as the thickness of the optical disc at the supporting portion, wherein the data read/write is performed from the compensation sheet side of the optical disc by a driving device. A method of fabricating the same is also disclosed.

### BACKGROUND OF THE INVENTION

a) Field of the Invention

The invention relates to an optical disc and a method of fabricating the same and, more particularly, to an optical disc, for which the data read/write is performed from the compensation sheet side of the optical disc, and a method of fabricating such optical disc.

b) Description of the Related Art

An optical disc can store data in different formats and is the most convenient storage medium among the optical storage media of the new generation. In addition, an optical disc can be applied in many fields, including library archives, data backup, electronic publication, image data storage, and personal medical record management.

Shown in FIG. 1A is the top view of a conventional optical disc 1; the conventional optical disc 1 is annular and can be divided into an inner supporting portion 11 and an outer recording portion 12. The detailed structure of the conventional optical disc 1, as shown in FIG. 1B, includes an annular substrate 13, a coating layer 14, and a compensation sheet 15. The coating layer 14 includes a recording layer 141, a reflection layer 142, and a protection layer 143, which are sequentially stacked on the annular substrate 13, forming the recording portion 12. The compensation sheet 15 is attached to the annular substrate 13 to cover the coating layer 14, thus yielding the product of optical disc 1.

Most of the aforementioned type of optical discs record data by using groove tracks. As shown in FIG. 1B, the surface of the annular substrate 13 that corresponds to the recording portion 12 includes groove tracks 131, and a laser light 3 emitted from a read/write head 2 of a driving device is focused on the recording layer 141 in the groove tracks 131, in which the data read/write is performed on the optical disc 1 along the rail of groove tracks 131. FIG. 2 shows a conventional process of making an annular substrate 13 having groove tracks 131. First, a laser beam recorder (LBR) is used to expose and develop a photoresist 412 on a substrate 411, forming groove tracks 4121 that correspond to control signals of optical disc; the substrate 411 together with the photoresist 412 will be referred to as a Resist Master Disc 41 hereafter for simplicity. Next, the control signals are reproduced to a metal thin board by electroforming process, forming an imprint master mold including protruding tracks 421 that correspond to the control signals; the imprint master mold is commonly referred to as a “Father Stamper” 42. The Father Stamper 42 is then reproduced to form a “Mother Stamper” 43 including groove tracks, and the “Mother Stamper” 43 is further reproduced to form a “Son Stamper” 44 including protruding tracks. Lastly, the “Son Stamper” 44 is used to mass-produce the annular substrate 13. It can be seen from the aforementioned production process that both of the “Father Stamper” 42 and the “Son Stamper” 44 which have protruding tracks can be used to produce the annular substrate 13. However, mass-production would cause the imprint master mold to wear off and thus can no longer be used. Since the cost to make the “Father Stamper” 42 is high, when the annular substrate 13 needs to be mass-produced, the “Mother Stamper” 43 is mass-reproduced, which is then further reproduced to form the “Son Stamper” 44 that is used to produce the annular substrate 13. Note that the “Mother Stamper” 43 cannot be utilized to actually produce the annular substrate 13.

When producing the annular substrate 13, each of the optical or mechanical parameters, like “birefringence” and disc warpage, has to be precisely controlled. In the actual production process, trade-offs exist between many parameters. For example, if production parameters are to be adjusted to reduce the “birefringence” of the annular substrate 13, other types of parameters may be degraded. Therefore, it is difficult to adjust each parameter so that all of the parameters are in a specified range. Moreover, as shown in FIG. 1B, the data read/write on the conventional optical disc 1 is performed by directing the laser light 3 from the side of the optical disc 1 where the annular substrate is situated, and therefore, the extra aberration of the annular substrate 13 caused by the incident laser light 3 has to be taken into consideration. Consequently a stricter requirement on optical characteristic of the annular substrate 13 is necessary; hence, the annular substrate 13 cannot be produced with a low quality and low priced plastic material.

Furthermore, the optical disc 1 uses groove tracks 131 to read/write data, that is, the concave part is used. When the recording layer is coated by spin coating method, in order to have a sufficient amount of dye in the groove tracks 131 so that the strength requirement for each electrical signal to perform reading/writing can be met, the depth of groove tracks 131 has to be increased. In general, the depth of groove tracks is required to be at least ¼ of the wavelength of the laser light while passing through the substrate; the depth of groove tracks of conventional optical discs is around 140 nm to 200 nm, and the width of groove tracks is around ⅓ of the track spacing. Accordingly, when this type of annular substrate 13 is produced by injection molding, stricter production conditions, such as slower injection speed and higher mold temperature, are a must to stably duplicate the precise indentations on the imprint master mold and produce an annular substrate having the aforementioned optical and mechanical parameters. Therefore, the production rate of an annular substrate cannot be further increased, which in turn disadvantages the reduction of production cost.

Concluding from above, how to simplify the adjustment of parameters of optical discs and increase production rate so that production cost of optical discs can be effectively reduced is the goal to be achieved.

### SUMMARY OF THE INVENTION

In view of the aforementioned problems, an object of the invention is to provide an optical disc and a method of fabricating such optical disc, which can simplify the adjustment of the parameters of the optical disc and increase the production rate to effectively reduce the production cost of the optical disc.

To achieve the aforementioned object, an optical disc of the invention, driven by a driving device for reading/writing data, includes: an annular substrate, a coating layer, and a compensation sheet. The annular substrate has a supporting portion, a recording portion surrounding the supporting portion, and a recording surface corresponding to the recording portion. The coating layer is formed on the recording surface for recording data. The compensation sheet is attached to the annular substrate, such that the coating layer is sandwiched between the annular substrate and the compensation sheet, and that the thickness of the optical disc at the supporting portion and at the recording portion are the same, wherein the data read/write is performed from the compensation sheet side of the optical disc by the driving device.

The invention also discloses a method of fabricating an optical disc, which is driven by a driving device for reading/writing data. The method includes: fabricating an annular substrate by using an imprint master mold, the annular substrate having a supporting portion, a recording portion surrounding the supporting portion, and a recording surface corresponding to the recording portion; forming a coating layer on the recording surface for recording data; and attaching a compensation sheet to the annular substrate, such that the coating layer is sandwiched between the annular substrate and the compensation sheet, and that the thickness of the optical disc at the supporting portion and at the recording portion are the same, wherein the data read/write is performed from the compensation sheet side of the optical disc by the driving device.

According to the optical disc of the invention, since the data read/write is performed from the compensation sheet side of the optical disc, the requirement on the optical characteristic of the annular substrate is less strict and so relatively inferior plastic material can be used to produce the annular substrate. In addition, when the parameters of the annular substrate are being adjusted, only the mechanical characteristics and the transcript characteristics of the annular substrate need to be considered, but not the optical characteristics of the annular substrate. In addition, the annular substrate can be produced with an imprint master mold that is formed from two rounds of reproduction. Moreover, since the access of data is performed from the compensation sheet side, the depth of the groove (or protruding) tracks can be greatly reduced to below ¼ of the wavelength, which is beneficial in increasing the production rate of products made by injection molding. The aforementioned advantages result in an optical disc that is easy to produce and has a high production yield, which in turn increases the production rate and further reduces the production cost.

### BRIEF DESCRIPTION OF THE DRAWINGS

FIG. 1A is a schematic diagram illustrating a top view of a conventional optical disc.

FIG. 1B is a schematic diagram illustrating the structure of a conventional optical disc.

FIG. 2 is a schematic diagram illustrating a method of fabricating an annular substrate of a conventional optical disc.

FIG. 3 is a schematic diagram illustrating the structure of an optical disc according to a preferred embodiment of the invention.

FIG. 4 is a flow chart illustrating a method of fabricating an optical disc according to a preferred embodiment of the invention.

FIG. 5A illustrates a method of fabricating an annular substrate of an optical disc of the invention.

FIG. 5B illustrates another method of fabricating an annular substrate of an optical disc of the invention.

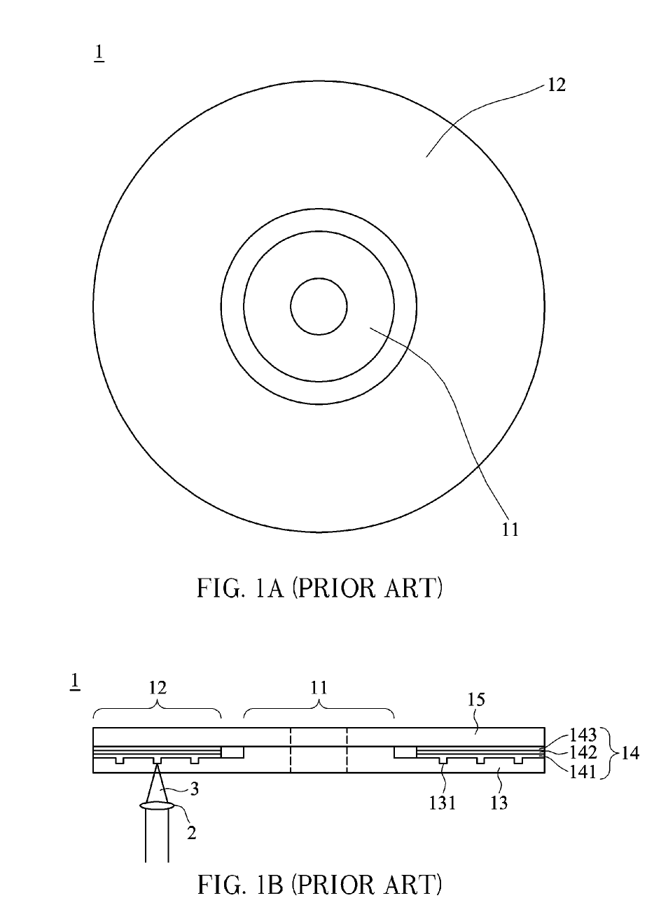

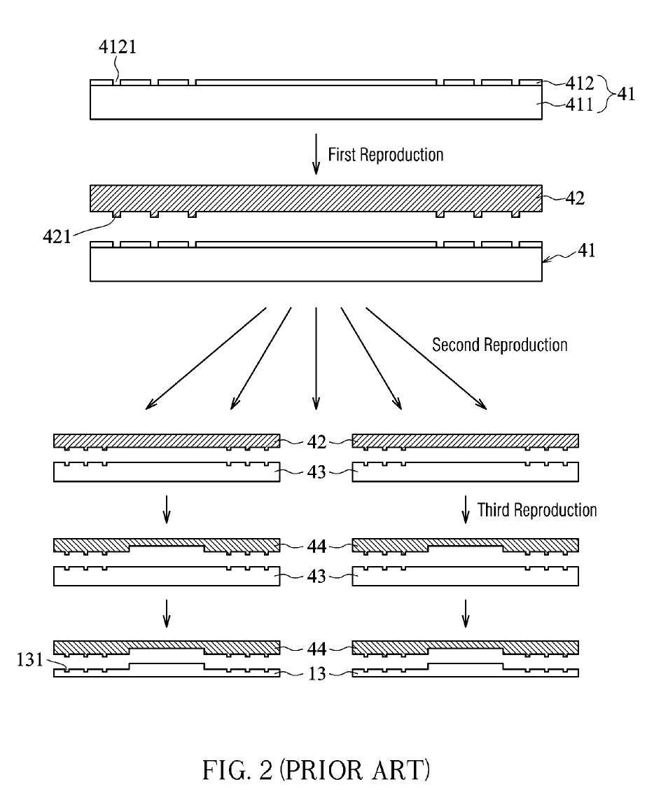

### DETAILED DESCRIPTION OF THE INVENTION

An optical disc and a method of fabricating the same according to a preferred embodiment of the invention will be described below with reference to the drawings, wherein the like reference numerals denote the like components.

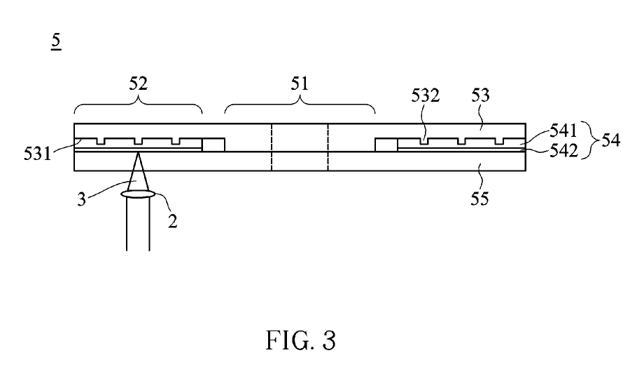

Referring to FIG. 3, an optical disc 5 according to an embodiment of the invention is driven by a driving device for reading/writing data. The optical disc 5 includes an annular substrate 53, a coating layer 54, and a compensation sheet 55. The annular substrate 53 has a supporting portion 51, a recording portion 52 surrounding the supporting portion 51, and a recording surface 531 corresponding to the recording portion 52. The coating layer 54 is formed on the recording surface 531 for recording data. The compensation sheet 55 is attached to the annular substrate 53 with the coating layer 54 sandwiched between the compensation sheet 55 and the annular substrate 53. The thickness of the optical disc 5 at the supporting portion 51 and the thickness of the optical disc 5 at the recording portion 52 are substantially the same. The driving device reads and writes data from the side of the optical disc 5 where the compensation sheet 55 is situated. In other words, to read and write data, a laser light 3 emitted by a read/write head 2 of the driving device enters the optical disc 5 from the compensation sheet 5 side, passes through the compensation sheet 5, and is reflected by the coating layer 54, as shown in FIG. 3.

The coating layer 54 includes a reflection layer 541 and at least one recording layer 542. The reflection layer 541 is formed on the recording surface 531, and subsequently the recording layer 542 is formed on the reflection layer 541. The reflection layer 541 is composed of metal and the recording layer 542 is composed of organic dye or inorganic dye.

It is suggested that in order to obtain a better reading/writing effect, the transmittance of the laser light 3 emitted by the driving device be greater than 80% while passing through the compensation sheet 55. As well, the transmittance of the laser light 3 emitted by the driving device is suggested to be greater than 80% while passing through a heat melting glue or an UV cure, which is used to attach the compensation sheet 55.

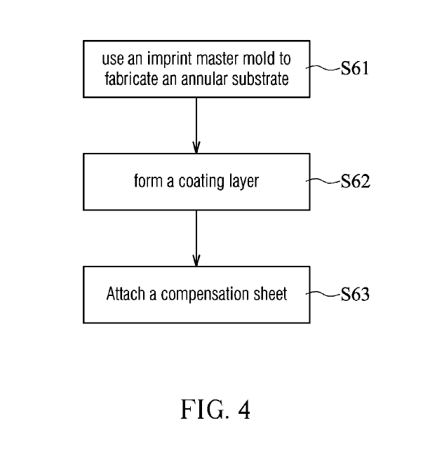

A method of fabricating an optical disc 5 according to an embodiment of the invention is shown in FIG. 4. First, an annular substrate 53 is fabricated by using an imprint master mold (S61). The structure of the annular substrate 53 is as aforementioned and therefore is not described here. Second, a coating layer 54 is formed on a recording surface 531 of the annular substrate 53 (S62); the coating method can be spin coating, vacuum evaporation, or vacuum sputtering. Lastly, a compensation sheet 55 is attached to the annular substrate 53 with the coating layer 54 sandwiched between the annular substrate 53 and the compensation sheet 55 (S63), such that the thickness of the optical disc 5 at a supporting portion 51 of the annular substrate 53 is substantially the same as the thickness of the optical disc 5 at a recording portion 52 of the annular substrate 53.

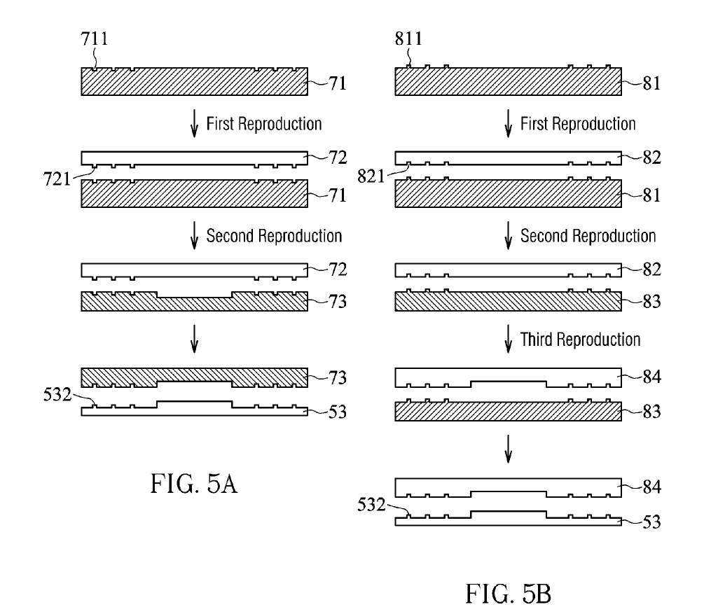

It is to be noted that the conventional optical disc 1 records data on the groove tracks 131 of the annular substrate 13, which are on the surface that is closer to the read/write head 2 of the driving device. Since the optical disc 5 of the invention performs data read/write from the compensation sheet 5 side, in order to record data on a surface that is closer to the read/write head 2 of the driving device, protruding tracks 532 must be used. Take the example of FIG. 3, wherein an annular substrate 53 having protruding tracks 532 is shown, the process of making the imprint master mold is shown in FIGS. 5A and 5B. Referring to FIG. 5A, first, a “Resist Master Disc” 71 that includes groove tracks 711 corresponding to control signals of optical disc is manufactured. Next, an imprint master mold 72 including protruding tracks 721 is formed from the first reproduction of the “Resist Master Disc” 71; the protruding tracks 721 correspond to the groove tracks 711. By using the imprint master mold 72, an imprint master mold 73 including groove tracks is formed from the second reproduction. Lastly, the imprint master mold 73 obtained from the two rounds of reproduction is used to fabricate the annular substrate 53 including protruding tracks 532.

FIG. 5B shows another method of fabricating the annular substrate 53 including protruding tracks 532. First, a “Resist Master Disc” 81 that includes protruding tracks 811 corresponding to control signals of optical disc is manufactured. Next, an imprint master mold 82 including groove tracks 821 is formed from the first reproduction of the Resist Master Disc 81; the groove tracks 821 correspond to the protruding tracks 811. Then, by using the imprint master mold 82, an imprint master mold 83 including protruding tracks is formed from the second reproduction and, by using the imprint master mold 83, an imprint master mold 84 including groove tracks is formed from the third reproduction. Lastly, the imprint master mold 84 obtained from the three rounds of reproduction is used to fabricate the annular substrate 53 including protruding tracks 532. Although currently the annular substrate 53 is usually fabricated by using the imprint master mold 84 obtained from three rounds of reproduction, it can be seen from the process of making imprint master mold that the imprint master mold obtained from one round of reproduction can also be used to fabricate the annular substrate 53.

From the process of fabricating an annular substrate as shown in FIGS. 5A and 5B, it can be inferred that, regardless of the type of optical discs to be made, for example, an optical disc including groove tracks or protruding tracks, or a dual layer/single-sided optical disc for reading/writing, a person skilled in the art can flexibly change the fabricating process depending on the demands. Consequently, the imprint master mold obtained from two rounds of reproduction (“Mother Stamper”) can also be used to fabricate annular substrates, and thus the relatively complicated process of fabricating imprint master mold using three rounds of reproduction can be simplified and the more severe signal error that may be caused can be reduced.

According to the optical disc of the invention, since the data read/write on the optical disc is performed from the compensation sheet side, the requirement on the optical characteristics of the annular substrate is not as strict. For example, relatively inferior plastic material with lower quality and at lower price can be used to fabricate the annular substrate, and even the invalid material generated during the production process, or the defective product from the production process, can all be recycled several times and reused in the production, thereby effectively lowering the material cost.

Moreover, the annular substrate can be made of nontransparent material, therefore the coating requirement on the reflection layer can be reduced. For example, the thickness of the reflection layer can be thinner, or uneven coating of the reflection layer can also satisfy the standard specification of reflection characteristic. In other words, the production process of optical discs can have a broader range of quality control standards, resulting in an increased number of qualified products, which also means a higher production yield, and thus the production cost of optical discs is relatively lowered.

Furthermore, the optical disc of the invention performs data read/write from the compensation sheet side, and so when adjusting the parameters of the annular substrate, only the mechanical characteristics and the transcript characteristics of the annular substrate need to be taken into consideration, but not the optical characteristics of the annular substrate. As such, when adjusting the mechanical characteristics and the transcript characteristics of the annular substrate, there is a broader range for parameter adjustments, which can effectively increase the production speed and product passing rate. In addition, as shown in FIG. 3, the annular substrate including protruding tracks can use methods, such as increasing the width of protruding tracks or the thickness of dye, to control the amplitude of guided signals of optical disc. Hence, the depth of the concave portion of the annular substrate can be relatively shallower, and so the annular substrate can be fabricated at a relatively faster production rate, resulting in a further reduction of production cost. For example, for the annular substrate including protruding tracks, the height of its protruding tracks is less than 60 nm; for the annular substrate including groove tracks, the depth of its groove tracks is also less than 60 nm.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. For example, the optical disc of the invention can be of any size, such as an optical disc with its diameter between 70 mm and 90 mm, or 110 mm and 130 mm. Moreover, the invention can also be implemented on an optical disc made of an annular substrate in which the thickness of its supporting portion is greater than the thickness of its recording portion, wherein the thickness of the supporting portion is between 0.66 mm and 1.6 mm. Therefore, the scope of the appended claims should be accorded the broadest interpretation so as to encompass all such modifications and similar arrangements.

What is claimed is:

1. An optical disc, driven by a driving device for reading/writing data, the optical disc comprising:
an annular substrate having a supporting portion, a recording portion surrounding the supporting portion, and a recording surface corresponding to the recording portion;
a coating layer formed on the recording surface for recording data; and
a compensation sheet attached to the annular substrate, such that the coating layer is sandwiched between the annular substrate and the compensation sheet, and that the thickness of the optical disc at the supporting portion and at the recording portion are the same, wherein the data read/write is performed from the compensation sheet side of the optical disc by the driving device.

2. The optical disc as described in claim 1, wherein the coating layer further comprises:
a reflection layer formed on the recording surface; and
at least one recording layer formed on the reflection layer.

3. The optical disc as described in claim 2, wherein the reflection layer is composed of metal.

4. The optical disc as described in claim 2, wherein the recording layer is composed of organic dye or inorganic dye.

5. The optical disc as described in claim 1, wherein the recording surface has a protruding track, and the height of the protruding track is less than 60 nm.

6. The optical disc as described in claim 1, wherein the recording surface has a groove track, and the depth of the groove track is less than 60 nm.

7. The optical disc as described in claim 1, wherein the transmittance of a laser light emitted by the driving device is greater than 80% while passing through the compensation sheet.

8. The optical disc as described in claim 1, wherein the compensation sheet is attached to the annular substrate by using heat melting glue or UV cure.

9. The optical disc as described in claim 8, wherein the transmittance of a laser light emitted by the driving device is greater than 80% while passing through the heat melting glue or the UV cure.

10. The optical disc as described in claim 1, wherein the thickness of the supporting portion of the annular substrate is greater than the thickness of the recording portion of the annular substrate.

11. A method of fabricating an optical disc, wherein the optical disc is driven by a driving device for reading/writing data, the method comprising:
fabricating an annular substrate by using an imprint master mold, the annular substrate having a supporting portion, a recording portion surrounding the supporting portion, and a recording surface corresponding to the recording portion;
forming a coating layer on the recording surface for recording data; and
attaching a compensation sheet to the annular substrate, such that the coating layer is sandwiched between the annular substrate and the compensation sheet, and that the thickness of the optical disc at the supporting portion and at the recording portion are the same, wherein the data read/write is performed from the compensation sheet side of the optical disc by the driving device.

12. The method of fabricating an optical disc as described in claim 11, wherein the imprint master mold is obtained by two rounds of reproduction of a resist master disc with control signals of the optical disc engraved thereon.

13. The method of fabricating an optical disc as described in claim 11, wherein the imprint master mold is obtained by one time or three rounds of reproduction of a resist master disc with control signals of the optical disc engraved thereon.

14. The method of fabricating an optical disc as described in claim 11, wherein the step of forming the coating layer comprises:
coating a reflection layer on the recording surface; and
coating at least one recording layer on the reflection layer.

15. The method of fabricating an optical disc as described in claim 14, wherein the reflection layer is composed of metal.

16. The method of fabricating an optical disc as described in claim 14, wherein the recording layer is composed of organic dye or inorganic dye.

17. The method of fabricating an optical disc as described in claim 11, wherein the recording surface has a protruding track, and the height of the protruding track is less than 60 nm.

18. The method of fabricating an optical disc as described in claim 11, wherein the recording surface has a groove track, and the depth of the groove track is less than 60 nm.

19. The method of fabricating an optical disc as described in claim 11, wherein the transmittance of a laser light emitted by the driving device is greater than 80% while passing through the compensation sheet.

20. The method of fabricating an optical disc as described in claim 11, wherein the compensation sheet is attached to the annular substrate by using heat melting glue or UV cure.

21. The method of fabricating an optical disc as described in claim 20, wherein the transmittance of a laser light emitted by the driving device is greater than 80% while passing through the heat melting glue or the UV cure.

22. The method of fabricating an optical disc as described in claim 11, wherein the thickness of the supporting portion of the annular substrate is greater than the thickness of the recording portion of the annular substrate.
